(19) United States
(12) Patent Application Publication
(10) Pub. No.: US 2026/0268535 A1
(43) Pub. Date: Sep. 10, 2026

(54) SYNTHETIC IMAGE GENERATION SYSTEM

(71) Applicant: OpenAI OpCo, LLC, San Francisco, CA (US)

(72) Inventors: Douglas Stuart Brodie, San Jose, CA (US); Matthew Allen, Menlo Park, CA (US); Adam Cue, San Francisco, CA (US)

(21) Appl. No.: 19/556,909

(22) Filed: Mar. 4, 2026

Related U.S. Application Data
(60) Provisional application No. 63/767,471, filed on Mar. 5, 2025.

(51) Int. Cl. G06T 11/00; G06F 16/532; G06F 16/583

(52) U.S. Cl. CPC G06T 11/00; G06F 16/532; G06F 16/583

(57) ABSTRACT

A method for generating a set of synthetic images corresponding to a subset of images of an image collection may include receiving a collection of captured images captured by an electronic device, providing the collection of captured images as input to an image selection model trained to select, from the collection of captured images, a subset of images that satisfy a salience condition. The method may further include providing the subset of images to an image analysis model, receiving text-based summaries of the images as output from the image analysis model, and generating a prompt for an image generation model. The method may further include receiving, as output from the image generation model, a synthetic image including a computer-generated representation of the image content of the image, and causing the synthetic image to be displayed on an image display device.

### CROSS-REFERENCE TO RELATED APPLICATION(S)

This application is a nonprovisional patent application of and claims the benefit under 35 U.S.C. §119(e) of U.S. Provisional Patent Application No. 63/767,471, filed Mar. 5, 2025, and titled “Synthetic Image Generation System,” the contents of which are incorporated herein by reference in its entirety.

### FIELD

The subject matter of this disclosure relates generally to image processing systems, and, more particularly, synthetic image generation systems.

### BACKGROUND

Many modern electronic devices incorporate cameras for various purposes. For example, cameras may be incorporated into personal electronic devices such as mobile phones, smart glasses, and earbuds for image capture, video recording, and the like. Captured images may be stored for later viewing. Modern electronic devices may allow users to capture, store, and edit hundreds or thousands of images.

### SUMMARY

A method for generating a set of synthetic images corresponding to a subset of images of an image collection may include receiving a collection of captured images captured by an electronic device, each image of the collection of captured images having image content, providing the collection of captured images as input to an image selection model trained to select, from the collection of captured images, a subset of images that satisfy a salience condition, and receiving, as output from the image selection model, respective identifiers of the images of the subset of images that satisfy the salience condition. The method may further include, for an image of the subset of images that satisfies the salience condition, providing the image as input to an image analysis model and receiving, as output from the image analysis model, a text-based summary of the image content of the image, and generating a prompt for an image generation model, the prompt including the text-based summary of the image. The method may further include receiving, as output from the image generation model, a synthetic image including a computer-generated representation of the image content of the image, and causing the synthetic image to be displayed on an image display device.

The electronic device may be an earbud, and the electronic device may include a first camera having a first field of view and a second camera having a second field of view different from the first field of view. The first camera and the second camera are positioned in the earbud such that the first camera is aimed in a first direction when the earbud is worn and the second camera may be aimed in a second direction different from the first direction when the earbud is worn. The first direction may be oriented laterally relative to the electronic device, and the second direction may be a forward direction relative to the electronic device. The electronic device may be a wearable electronic device, and the images of the collection of captured images captured by the wearable electronic device may be automatically captured at periodic intervals over a time period. At least a subset of images of the collection of captured images captured by the electronic device may be captured in response to a voice command.

The image selection model may be trained using a plurality of annotated image sets, and an annotated image of an annotated image set of the plurality of annotated image sets may be annotated with a salience score.

An image of the subset of images may be associated with image metadata, and the image metadata may be provided to the image analysis model as an additional input associated with the image. The image analysis model may provide, as an additional output, an identifier of an image subject in the image based at least in part on the image metadata, and the prompt may further include the identifier of the image subject. The image metadata may include location information indicating an image capture location of the image and camera orientation information indicating an orientation direction of a camera when the image was captured. The collection of captured images may include one or more still images excerpted from a video captured by the electronic device.

A method for generating a set of synthetic images corresponding to a subset of a collection of captured images may include selecting a captured image from the collection of captured images, the selection based at least in part on a salience of image content of the captured image, the captured image associated with image metadata, and providing the captured image as input to an image analysis model. The method may further include receiving, as output from the image analysis model, a text-based summary of the image content of the captured image, generating a prompt for an image generation model, the prompt including the text-based summary of the image content of the captured image and at least one supplemental data item from the image metadata. The method may further include receiving, as output from the image generation model, a synthetic image including a computer-generated representation of the image content of the captured image, wherein the computer-generated representation is generated base at least in part on the at least one supplemental data item, and causing the synthetic image to be displayed on an image display device.

Selecting the captured image may include receiving a collection of captured images captured by an electronic device, providing the collection of captured images as input to an image selection model trained to select, from the collection of captured images, a subset of images that satisfy a salience condition, and receiving, as output from the image selection model, an identifier of the captured image.

The method may further include providing the captured image to an image feature identification engine that may be configured to identify features of the captured image to be accurately represented in the synthetic image, and receiving, as output, from the image feature identification engine, an identifier of a region of the captured image corresponding to a candidate feature to be accurately represented in the synthetic image. The operation of generating the prompt for the image generation model may further include incorporating the identifier of the region of the captured image in the prompt, and the synthetic image may include an accurate representation of the candidate feature.

The method may further include generating an image segment file corresponding to a segment of the captured image, the segment of the captured image including the candidate feature, and providing the image segment file as an additional input to the image generation model in conjunction with the prompt. The image feature identification engine may be configured to identify the candidate feature based at least in part on a determination that the candidate feature appears in at least one other image in the collection of captured images. The image feature identification engine may be configured to identify the candidate feature based at least in part on a determination that the candidate feature appears in a reference image.

A method for generating a set of synthetic images corresponding to a subset of a collection of captured images may include receiving the collection of captured images, the collection of captured images automatically captured by a wearable camera while the wearable camera is worn, and providing the collection of captured images as input to an image selection model. The image selection model may be trained to select, from the collection of captured images, a subset of captured images that satisfy a salience condition, and the method may further include receiving, as output from the image selection engine, the subset of captured images, and for an image of the subset of captured images, generating, with an image generation model, a synthetic image including a computer-generated representation of image content of the image.

The collection of captured images may be captured by the wearable camera periodically at a time interval, and the time interval may be adjusted by the wearable camera based at least in part on geolocation data associated with the wearable camera.

The method may further include, prior to providing the collection of captured images as input to the image selection engine, determining a similarity score between at least two images of the collection of captured images, and in accordance with a determination that the similarity score satisfies a similarity condition, selecting, from the at least two images, a single representative image to include in the collection of captured images that may be provided as input to the image selection engine.

The image of the subset of captured images may be provided to an image analysis engine, the image analysis engine may be configured to output a respective text-based summary for the image of the subset of captured images, and each respective text-based summary may be provided as input to the image generation model. The image analysis engine may receive one or more supplemental data items including at least an image capture location of the image of the subset of captured images, and the text-based summary for the image of the subset of captured images includes information about a location identified from the image capture location.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows example electronic devices incorporating cameras;

FIG. 1B shows example image capture perspectives;

FIG. 2A shows an example collection of captured images;

FIG. 2B shows an example set of generated synthetic images;

FIG. 3 shows an example of an image synthesis pipeline;

FIG. 4 shows an example portion of an image synthesis pipeline;

FIG. 5A shows an example of image analysis;

FIG. 5B shows another example of image analysis;

FIG. 6 shows an example user interface for adjusting synthetic image generation; and

FIG. 7 depicts a sample electrical block diagram of an electronic device that may perform the operations described herein.

### DETAILED DESCRIPTION

Modern electronic devices, such as mobile phones and wearable devices, increasingly incorporate small yet sophisticated cameras that allow users to capture high-quality images (e.g., still and/or video images). However, even these highly compact and portable devices require a user to retrieve the device, frame the image, and capture the image. This process, while simple, may still be a cumbersome interruption, and may require a person to take their attention away from their immediate surroundings and companions. Because of this, people may miss opportunities to capture memories of their experiences.

In some cases, as described herein, wearable devices include cameras that are configured to automatically capture images of a user's environment. For example, a compact camera configured to passively capture images throughout the day may be embedded in the enclosure of an earbud, the rim of a pair of glasses, a watch, a necklace, any other wearable item, or the like. This may be accomplished via a continuous video feed, periodic still image capture, or contextual triggers, such as when a user's geolocation indicates they are near a landmark or with a friend or other known companion. By automatically capturing images, a user need not be interrupted with the various processes of manual photography (though image capture may be triggered by additional input by the user, such as a voice command to capture images at a specific moment or a touch-based gesture indicating that images should be captured).

Automatic image captures may lack the deliberate composure of a manually composed and captured photograph. Automatically captured images may leave desired subjects obscured, or contain an overall composition that is undesirable to the user. For example, images taken from a camera embedded within an earbud worn by a cyclist may be partially obstructed by a helmet strap or be captured at an undesirable angle due to the neck and head posture of the cyclist. Similarly, even an image captured in response to deliberate input by the user may still be poorly framed or composed. Accordingly, the techniques described herein use captured images to generate synthetic images that contain computer-generated representations of the scene content and, optionally, are evocative of the emotional context in which the automatically captured image was taken, but which have improved composition, content, and, optionally, different artistic stylings. More particularly, by using synthetic image generation techniques, the framing, angle, composition, lighting, positioning of subjects, and overall style of the captured image may be changed such that the resulting synthetic image is desirable and appealing to the user or otherwise matches specified criteria. In addition, salient objects within images may be emphasized as compared to their corresponding depiction in the captured image. For example, a captured image may contain only a small, distant portion of a particular landmark, whereas the corresponding synthetic image may present the landmark in a more central, prominent fashion. Further, synthetic images may be more evocative of the memory than an exact or edited version of the automatically captured image or even than a deliberately composed and manually captured image.

Because a large number of images may be automatically captured using the techniques described herein, the collection of captured images may be culled or filtered such that only certain images are selected as the basis for synthetic image generation. For instance, an image selection engine may evaluate the identifiable contents of an image, the color saturation, edge clarity, and perspective of the image, as well as supplemental data items associated with the image, in order to determine the salience of the image and/or otherwise determine whether to select the image to be used as the basis for a synthetically generated image. Similarly, images that are highly similar (e.g., such as a series of images captured while a user is stationary) may be culled such that only a single representative image from the set of similar images is retained.

Once a subset of images has been identified or otherwise selected from a collection of captured images, the subset of images may then be provided to an image analysis engine, which may include one or more machine learning models trained to output descriptions or annotations of images based on their composition, contents, contextual data, and the like, as well as determine salience scores for particular contents within the captured image. Example techniques for training particular models related to the generation of synthetic images will be described in detail herein. The image analysis system as described herein may be configured to produce a text-based summary of the image, such that the summary includes descriptions of the contents of the image, the perspective and composition of the image, contextual data, and other similar information identified by the image analysis engine.

For a selected image, a final text-based prompt may be produced and provided to a synthetic image generation engine. For example, a prompt generation engine may incorporate aspects of the text-based summary of the image in a prompt that is provided to the synthetic image generation engine, and the synthetic image generation engine may produce a synthetic image based on the prompt (and incorporating features identified in the text-based summary of the image). The image analysis and generation process may be applied to multiple images of the collection, resulting in a collection of synthetic images that capture the most salient, significant, evocative, interesting, and/or important images over a time period. Moreover, since the synthetic images are generated based on the content of the captured images (and are not merely edited versions of the captured images), the synthetic images may be more evocative of a particular memory or moment in time, as opposed to an exact reproduction. Further, the user may request that synthetic images are generated such that they resemble particular styles distinct from ordinary photography, such as an ink-and-watercolor painting style or a ligne claire illustration style. The user may also adjust the degree to which the contents and composition of the synthetic image accurately reflect the automatically captured image.

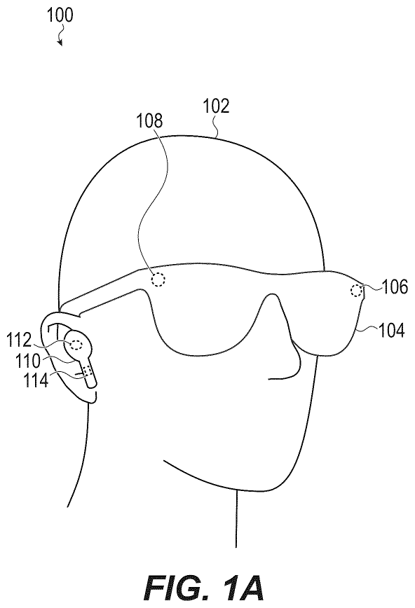

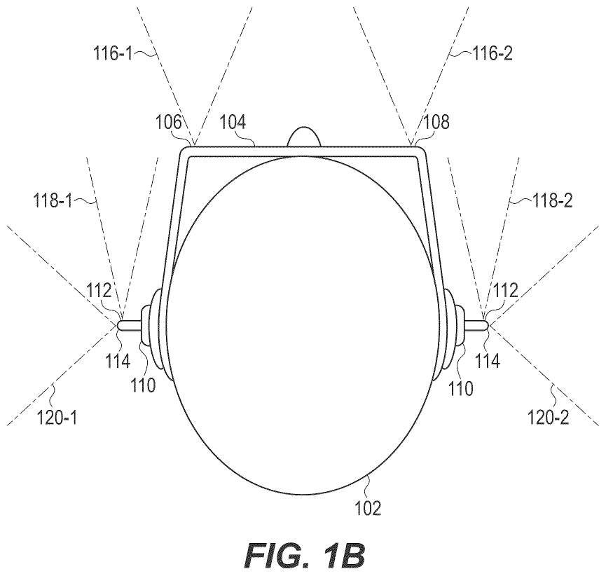

FIG. 1A illustrates example wearable electronic devices 104, 110 that include cameras 106, 108, 112, 114 that may be used to automatically capture images. For example, as described herein, the cameras 106, 108, 112, 114 may be used to capture images at periodic time intervals while the wearable electronic devices 104, 110 are being worn by a user 102. The wearable electronic devices 104, 110 may be worn for a variety of purposes distinct from and in addition to capturing images as described herein, such as playing music or correcting vision. Accordingly, the wearable electronic devices 104, 110 may be worn routinely and/or over relatively long periods of time, such that the cameras may capture numerous images in a “memory stream” style collection. Since many such images may not be deliberately or intentionally composed, the images from such cameras may be processed, as described herein, to produce a set of synthetic images that are representative of the interesting, salient, or important moments or scenes in the collection of captured images.

As illustrated in FIG. 1A, the wearable electronic device 104 is eyewear (e.g., “smart glasses”), and the cameras 106, 108 are incorporated into the frame or rims of the eyewear. The cameras 106, 108 are front-facing, but it will be understood that the cameras may be embedded in other positions within the eyewear, such as within the arms of the eyewear in a peripheral-facing orientation. The wearable electronic device 110 is a wireless earbud, and the cameras 112, 114 are incorporated into the housing of the earbud. The cameras 112, 114 may be aimed in different directions, for instance, such that the first camera 112 is aimed forward or in a generally front-facing direction, and the second camera 114 is aimed in a peripheral or generally side-facing direction. The cameras 112, 114 (and 106, 108) may have the same or similar imaging parameters and performance (e.g., the same or similar image sensors, lenses, fields of view, etc.), or they may differ. For example, in some cases, the cameras may have different imaging parameters and/or performance in order to capture different information. As one specific example, and as described with respect to FIG. 1B, the front-facing camera 112 may have a different field of view than the side-facing camera 114, thus facilitating the capture of multiple perspectives of a given scene or environment.

The cameras of the wearable electronic devices may comprise distinct imaging sensors and related lenses that capture images of varying resolution, perspective, framerate, and the like. For instance, the front-facing camera 114 of the wearable electronic device 110 may include an imaging sensor configured for high resolution still image capture, while peripheral-facing camera 112 may include an imaging sensor configured for continuous video capture. Similarly, it will be understood that either of the illustrated devices may include one or more additional cameras embedded in other positions, or include only a single camera. Further, these are merely a few examples of wearable electronic devices that include cameras. In other examples, the wearable electronic device may be a smart watch or bracelet, an action camera, electronic earrings, a smartphone, or the like. It will be appreciated that the wearable electronic devices may include additional functionalities and sensors, for instance, earbuds may contain microphones configured for teleconferencing or voice commands. As will be described later, these additional sensors may be utilized by the synthetic image generation system in a variety of additional ways.

FIG. 1B illustrates an example of the fields of view 116-1, 116-2, 118-1, 118-2, 120-1, 120-2, of the cameras 106, 108, 112, 114. As shown, fields of view 116-1, 116-2, 118-1, 118-2 are front-facing relative to the user 102, such that captured images are more likely to contain subjects that are directly in front of, and thus more likely to be observed by, the user. On the other hand, fields of view 120-1, 120-2 are peripheral-facing relative to the user such that captured images may contain subjects that are not seen by the user, and/or contain additional contextual information about the user's surroundings. As illustrated, the earbuds 110 are thus capable of capturing images including subjects directly in the user's view as well as subjects to the user's side or even rear. By capturing images from a variety of perspectives, more visual information about the user's environment may be preserved for incorporation in later synthetic image generation. For example, if an automatic image capture occurs while the user is looking down at their phone, the peripheral-facing cameras will still capture information about the user's surroundings, whereas the front-facing camera will primarily capture the user's phone screen, the user's hands, the ground, or the like. In some cases, the image capture perspectives of multiple cameras may overlap such that particular image contents, such as portions of the environment or elements thereof, are captured by multiple cameras. As a result, image stitching operations may be performed to combine multiple contemporaneous image captures into a single image capture. For instance, shared portions of contemporaneous image captures may be used by an image stitching system as reference points in defining the regions of the image captures where the stitching transformations and operations may be executed. As described herein, images that are evaluated and selected to serve as the basis for synthetic image generation may be or may include stitched images generated by stitching multiple images from one or multiple cameras.

Further, varying fields of view produce differing levels of perspective distortion. For instance, extension distortion may be observed in images of nearby subjects taken with a wide field of view, while compression distortion may be observed in images of distant subjects taken with a narrow field of view. Similarly, images captured at narrower fields of view tend to retain finer details in the environment more accurately, while images captured at wider fields of view tend to capture greater portions of the environment as a whole. As shown, the wearable electronic device 110 contains two cameras 112 and 114. The peripheral-facing camera 114 is shown with a wide-angle field of view 120-1, 120-2, while the front-facing camera 112 is shown with a narrow angle field of view 118-1, 118-2. As illustrated in FIG. 1B, by utilizing a narrower field of view in front-facing image capture perspectives, finer details in front of the user (e.g., details that are more likely to be noticed with particularity by the user, such as text) may be captured in greater detail while a broader variety of peripheral details (e.g., details that were outside of the user's view) may be broadly captured as additional context. In this way, a set of images may be captured that, as a whole, preserve the salient elements of the environment at the moment of capture. For example, a peripheral-facing camera may capture the likeness of a companion beside the user, while a front-facing camera may capture a landmark the user is directing their attention toward. It will be appreciated that these are merely a few examples of image capture perspectives and corresponding fields of view. In other examples, more or fewer cameras may be integrated into the image capture devices, lenses defining different or identical fields of view may be utilized, and the cameras may be positioned to face directions other than those explicitly described herein.

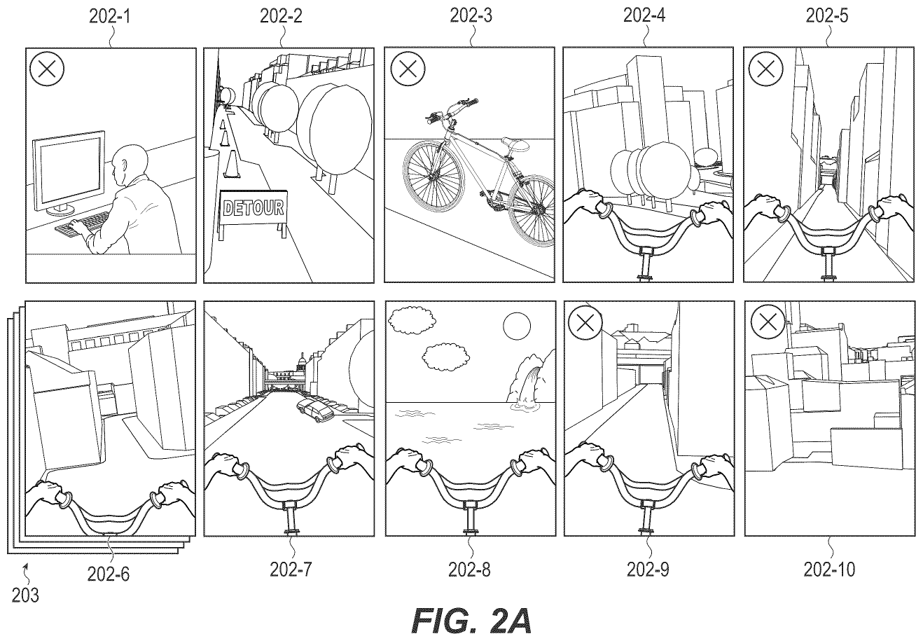

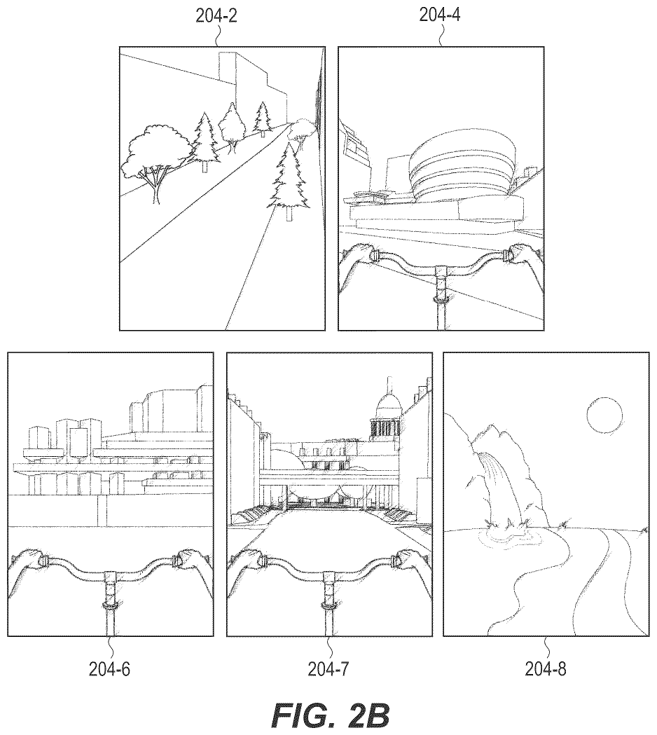

FIG. 2A illustrates an example of a collection of captured images that were captured over a period of time by an image capture device associated with the user, such as the wearable devices described with respect to FIGS. 1A-1B. The collection of captured images shown in FIG. 2A may represent an example image collection for which synthetic images may be generated as described herein. The collection of image captures may take the form of distinct still images, one or more video images, or a combination of both. Once a collection of image captures is formed, the collection is processed using an image selection engine to identify a subset of images to serve as the basis for synthetic image generation.

As mentioned, the image collection from which images are selected may contain automatically captured images. Automatic image captures may occur periodically over a particular time window or interval. For instance, image captures may be configured to occur automatically every fifteen minutes. In some examples, a dynamic time interval may be applied such that the time between automatic captures may be adjusted depending on the user's specific context. In this way, more captures may occur in contexts that are more likely to be salient to the user, and fewer captures may occur in contexts that are rote or banal to the user. For example, the interval between captures may be lengthened when the user is in their daily commute and shortened when the user is in a location they have never visited. Further, it will be appreciated that the application of a dynamic time interval may further conserve device power and system processing time.

An automatic image capture event may comprise a burst of consecutive image captures (e.g., burst image capture 203) rather than a single capture. When multiple images are automatically captured in this fashion, the likelihood of capturing only obstructed, blurry, or otherwise undesirable images is reduced. For example, if a user is in the process of turning their head when an automatic image capture occurs, the captured image may be blurred along the axis of the user's head rotation. By capturing a burst of images, the resulting set of image captures may include images captured before or after the user's head rotation such that at least a portion of the captured burst of images are not blurred. Where a burst of images is captured, the image selection engine (or an image culling or prefiltering operation) may select a single representative image (e.g., image 202-6) from the burst 203 to include in the set of candidate images. In some cases, the image selection engine (or another operation) may stitch together multiple images or portions thereof to generate an image to include in the set of candidate images.

As illustrated, captured images 202-2, 202-4, 202-6, 202-7, and 202-8 are selected by the image selection engine to be used as the basis for synthetic image generation. Correspondingly, captured images 202-1, 202-3, 202-5, 202-9, and 202-10 are discarded or otherwise not selected by the image selection engine. Images may be selected based on a broad variety of criteria, described in detail herein. The image selection engine may further be configured to identify similar images and select a representative image for further processing. For instance, images may be assigned similarity scores such that only a subset of the images with similarity scores exceeding a certain threshold are selected.

The image selection engine may be configured to select images based on their contents, composition, and the like, such that selected images are likely to correspond to moments that the user finds interesting, noteworthy, or otherwise desirable. To accomplish this, the image selection engine may be configured to evaluate the particular significance of specific contents identified within the image. For instance, the image selection engine may be configured to select images that contain famous landmarks or individuals that are known to the user (e.g., friends, family, etc.).

Various techniques may be applied to evaluate images to determine which images are selected by the image selection engine. For instance, the image selection engine may contain one or more models configured to select or aid in the selection of particular images from the input collection. As one example, the image selection engine may include a machine learning model, which may be trained with sets of training data that include images annotated with salience scores or values. So trained, the model may accept images (e.g., the images 202 in FIG. 2A) as inputs, and provide, as output, selections of images that are likely to be salient (e.g., based on a similarity to the salient images in the training data).

As described in greater detail herein, the particular annotations in the training data for an image selection model may be salience scores, such as binary salience scores or graduated salience scores, or plain-language descriptions of the prominence or significance of the training images or the contents therein. For example, the image selection training data may include, for each training image, an annotation indicating that the image as a whole is “salient,” or “not salient.” Further, annotations indicating salience may be assigned for specific contents within an image, such that the image selection models are thereby trained to correspondingly annotate the contents of automatically captured images (e.g., providing salience scores for particular subjects in an image).

As mentioned, the image selection engine may include one or more image selection models. Image selection models may be trained on training data, such as large image sets that have been manually reviewed and annotated. Annotations may include identifications of contents within an image, as well as ratings or scores for the salience of the image as a whole and the contents therein. As described herein, the ratings or scores for the salience of the images used for training may relate to the composition of the image, the particular contents of the image, and supplemental data relating to the image, and/or any other factors or considerations that are desired to be the basis for image selection. For example, a training image may include geolocational data as described, and the manual assignment of a salience score for the training image may be made in reference to the geolocational data. By training image selection models in this way, the image selection models may be trained to make determinations about the salience of images and image contents that reflect the particular factors or considerations that were used to annotate the training data. Thus, for example, if the training data includes annotations reflecting high salience for any images with people in them, then the image selection model may tend to assign high salience scores to input images that include people in them. In some cases, multiple image selection models may be used by the image selection engine, such as a first model that identifies salient images based on the presence of people, a second model that identifies salient images based on the presence of geographical landmarks, and so forth.

FIG. 2B illustrates an example of a collection of synthetic images that have been generated based on the collection of captured images selected by the image selection engine. More particularly, the image selection engine may have identified, from the images 202 in FIG. 2A, only the images 202-2, 202-4, 202-6, 202-7, and 202-8 as satisfying a salience condition. Thus, those images were subjected to further processing to ultimately result in corresponding synthetic images 204-2, 204-4, 204-6, 204-7, and 204-8 being generated. For example, as described herein, the selected images may be provided to an image analysis engine, such that text-based summaries of the selected images may be produced as output by the image analysis engine. These text-based summaries may then be used to generate a final prompt for the synthetic image generation system. As noted, because the synthetic images 204 are generated from a text-based prompt (which includes a text-based summary of the captured image), the images 204 are not merely edited versions of the captured images 202, but are instead synthetic images that are generated independently of the image files of the captured images 202 (though in some example embodiments, all or portions of the captured images 202 may be used by a synthetic image generation engine to produce synthetic images 204).

Because the synthetic images 204 are computer-generated, various image contents such as trees, buildings, vehicles, persons, and the like are unlikely to be identical to the captured images 202, and may even be significantly different. In some cases, particular contents of high salience may be emphasized, and particular contents of low salience may be omitted. Further, the synthetic images 204 may depict an entirely different composition and style (e.g., an oil painting style) relative to captured images 202. In this way, the synthetic image may have advantages over the related automatically captured image or a deliberately composed photograph taken in interruption of the user's activity (e.g., a photograph taken by a user after stopping their bike and taking out a smartphone). As shown, the synthetic images 204 illustrate examples of the types of changes, relative to captured images 202, that may result from the synthetic image generation operations.

For example, captured images 202-4 and 202-6 depict angled horizons, while corresponding synthetic images 204-4 and 204-6 depict level horizons. Further, captured images 202-2, 202-4, and 202-7 depict superfluous objects, such as road construction equipment, trees, and ambient traffic. The corresponding synthetic images 204-2, 204-4, and 204-7 do not depict these superfluous objects, such that important aspects and contents within the image are unobstructed or otherwise more prominently represented. Similarly, particular contents may differ between the captured images and their corresponding synthetic images. For example, the portion of the large, imposing building captured in 202-4 has been replaced with a different building in the corresponding synthetic image 204-4. Further, the trees and plazas of 202-4 are removed in the synthetic image 204-4, such that a clearer view of the building is presented.

Further, important image contents such as the landmark structures of 202-6 and 202-7 are displayed more prominently in corresponding synthetic images 204-6 and 204-7. A similar result is achieved between 202-8 and 204-8, where only the most salient features of 202-8 are depicted in 204-8 (e.g., the waterfall). It will be appreciated that these are only a few examples of the manners in which the synthetic images may differ from the corresponding captured images.

Because the synthetic image generation operations can result in significant changes to the image contents relative to the captured images, the image analysis engine as described herein may be configured to identify contents that the synthetic image should faithfully incorporate. For example, the image analysis engine may be configured to produce more detailed descriptions of particular contents associated with higher salience (or identify portions of the image that should be accurately or faithfully incorporated into the synthetic image). In this way, particular contents of a captured image may be emphasized, more accurately represented, or otherwise reinforced within a corresponding synthetic image. For example, the arms of the user as captured in images 202-4, 202-6, and 202-7 may be determined by the image analysis engine to have higher importance and/or fidelity requirements, and thus be described with greater detail or flagged for faithful incorporation into the synthetic image. Similarly, particular image contents may appear repeatedly throughout an image collection (e.g., the particular arms of the user), which may result in the image analysis engine identifying the recurring contents as being of particular importance. By identifying image contents in this way, the synthetic images generated may more closely correspond to the appearance of the arms as depicted in the corresponding selected image captures. Generally and broadly, identifying recurring contents in captured images in order to maintain consistency in those contents in synthetic images may help avoid distracting or undesirable inconsistencies in contents that would be expected to be similar (e.g., the user's own arms, the user's bicycle, the user's shoes or clothes, the face or body of a companion, etc.).

As mentioned, particular contents of an image may have greater importance relative to other image contents, and thus the image analysis engine may be configured to include one or more image analysis models configured to identify particularly important image contents to be faithfully reproduced in the corresponding synthetic images. To accomplish this, the one or more image analysis models may be trained to evaluate the salience of said image contents (e.g., the salience of certain subjects within the image). Similar to other descriptions herein, the image analysis models may be trained using training data, such as annotated image sets containing annotations regarding the salience of discrete features within the image. As described herein, annotated image sets may contain annotations regarding the particular contents and aspects of images, as well as corresponding salience scores of the particular contents and aspects. Further, the salience determinations made by the image analysis engine may include, incorporate, or otherwise correspond to salience determinations as described with respect to the image selection engine.

It will be appreciated that isolating particular regions of an image for later incorporation may enable contents within said regions to be more accurately depicted in resulting synthetic images. For instance, a region of image 202-7 may be associated with a particular landmark, and thus the identification engine may produce pixel coordinates for the region of the image containing the landmark for later incorporation in the synthetic image generation process. FIG. 2B illustrates such a situation, in which the actual building in the captured image 202-7 is included in the synthetic image 204-7, despite the synthetic image 204-7 being fully synthesized (e.g., not including actual image data from the captured image). The image analysis engine may thus further include a feature identification engine configured to identify, extract, isolate, or otherwise segment particular contents within an image. In some examples, the feature identification engine may include one or more feature identification models trained to output an identifier for a particular region of the captured image, an excerpted portion of the captured image, or otherwise create a reference for a particular segment of the captured image. Thus, particular segments of a captured image containing highly salient contents may be isolated for later incorporation in the synthetic image generation process.

With reference to FIGS. 2A, 2B, a process by which the synthetic image 204-6 is generated from the captured image 202-6 is described. In particular, as shown in FIG. 2A, a particular captured image 202-6 may be selected from a burst 203 of image captures. The corresponding synthetic image 204-6 may then be generated such that particularly important contents depicted in 202-6, such as a large building with stark geometric features, is depicted more prominently and less obstructed by superfluous objects. Similarly, the overall artistic style and composition of the synthetic image may be modified to further make the synthetic image more desirable or evocative to the user.

To ensure that important contents are depicted faithfully in synthetic images, the image analysis engine may be configured to produce a text-based summary of the captured image contents. The text-based summary may include descriptions of particular image contents and aspects, such as a description of objects, landscapes, buildings, landmarks, people, and any other image content, as well as descriptions about the composition of the captured image. For example, a text-based summary of captured image 202-6 may describe the image as being taken from the perspective of a cyclist riding in a bike lane into a narrow alley leading to the landmark. The text-based summary for the captured image produced by the image analysis engine may then be provided as input to a prompt generation engine, along with image segments or identifiers of particular regions of images as described. The prompt generation engine may further be configured to accept other additional inputs, such as supplemental data items (e.g., image metadata, location information, timestamps, camera orientation or image parameters, etc.) as described herein.

The output of the prompt generation engine (e.g., an image synthesis prompt) may be provided as input to a synthetic image generation engine in order to generate synthetic images. As illustrated, each synthetic image 204 of the collection of generated synthetic images contains synthetic contents that correspond to at least some of the contents of associated captured images 202. As described herein, the synthetic images may depart from the corresponding captured image in a variety of ways. In some examples, the synthetic images may be generated in accordance with a particular style, for instance, a pastel illustration style. Synthetic images may further comprise perspectives different from the captured image (e.g., a synthetic image having a third person perspective may correspond to a captured image having a first-person perspective). Similarly, the particular angle or field of view of a synthetic image may be different from the captured image. For example, the canted angle of the horizon as depicted in image 202-4 is absent from corresponding synthetic image 204-4, which depicts a level horizon.

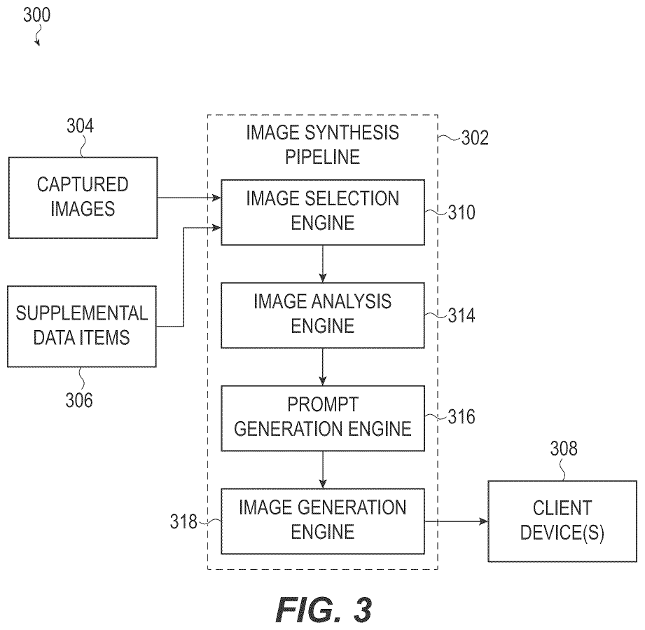

FIG. 3 depicts an image synthesis process 300. The image synthesis process includes image synthesis pipeline 302, through which captured images 304 and supplemental data items 306 may be processed in order to generate synthetic images. Image synthesis pipeline 302 includes an image selection engine 310, an image analysis engine 314, a prompt generation engine 316, and an image generation engine 318 as described herein. Captured images 304 may include a collection of captured images, one or more video recordings, or a combination of both, as described herein. Similarly, supplemental data items 306 may be available to other steps of the image synthesis pipeline 302 such that the supplemental data items are accessible to or otherwise available for reference or incorporation by the respective engines of the image synthesis pipeline 302. For example, supplemental data items 306 may be provided to or accessible by the image analysis engine 314, the prompt generation engine 316, and/or the image generation engine 318. Supplemental data items 306 may include, for example, the time at which an image was captured and the global positioning system (GPS) coordinates of the device at that time. The supplemental data items 306 may be used by the components of the image synthesis pipeline 302, as described in greater detail herein. For example, the image selection engine 310 may incorporate this information to determine that a particular image capture was outside of a user's ordinary routine, and thus more likely to represent a novel event (and thus may be more important to the user or otherwise not a routine event or experience). As another example, the supplemental data items may include information relating to a user's contacts, such that the image analysis engine 314 may determine that a particular person within an image capture is of close relation to the user, and thus more important to be accurately depicted in the corresponding synthetic images.

As described herein, the captured images 304 may include automatic image captures (e.g., images that are automatically captured at a particular time interval), and, optionally, image captures that are directly initiated by the user. As described herein, the image capture device may contain one or more microphones and associated circuitry that provide speech processing capabilities, enabling a user of the image capture device to request an image capture by issuing a voice command. For example, a user wearing earbuds (e.g., earbuds 110) may issue the voice command, “capture this moment,” triggering an out-of-interval capture by the image capture device. It will be appreciated that voice commands are only one manner in which a user may request an on-demand capture. In other examples, hand gestures presented to the cameras of the image capture device may trigger an image capture, or a particular touch input may be given, or a particular button of the image capture device may be pressed. Moreover, image captures that deviate from the automatic capture interval may be associated with image metadata that indicates the capture was specifically requested by the user. In this way, the image selection engine 310 may be configured to give specifically requested captures a higher priority during image selection.

As described herein, captured images may also be or include video images. Video recording may be accomplished similarly to still image capture as described herein. For instance, video recordings may be captured continuously, in accordance with periodic intervals of a time window, in response to image capture commands issued by the user, and the like. Further, a video feed may be analyzed in accordance with a rolling window, such that still images may be excerpted from the video feed at intervals. Accordingly, the image selection engine 310 may be configured to select images from a collection of still images, a video, or a combination of both.

The captured images 304 are received as input by the image selection engine 310. As described herein, the image selection engine 310 may be configured to evaluate the captured images to determine salience of image content within the captured image (e.g., via salience scores or other techniques), and may be further configured to make said evaluations in part based upon the supplemental data items 306. The image selection engine 310 may then select a subset of the captured images for further processing (e.g., captured images with high salience scores), such that the subset of captured images is provided as input to the image analysis engine 314.

In some cases, the image selection engine 310 may evaluate the significance of particular contents identified within the captured images 304. For example, the image selection engine 310 may determine that an image contains both the Golden Gate Bridge and a mailbox, and further determine that the Golden Gate Bridge is highly significant while the mailbox is insignificant or less significant. As described herein, the significance of images and the contents therein may be evaluated using various salience scoring and determination techniques.

The image selection engine 310 may further be configured to select images based on additional criteria, such as the sharpness of edges within the captured image, the obstruction of particular contents within the image, the color saturation of the image, and the like. Further, the image selection engine 310 may receive supplemental data associated with the images, such as geolocation data, weather data, other images captured by the user, contact information associated with the user, and the like. As described herein, the supplemental data available to the image selection engine 310 may provide additional basis upon which determinations about the significance of images and the contents therein may be made. For example, the supplemental data may include a geolocation history of the user indicating the particular locations and routes the user frequents. The geolocation history may indicate that, while a particular landmark identified within an image is significant, the user passes the landmark daily on their commute to work and is thus less likely to find an image of the landmark particularly significant, interesting, or otherwise desirable. In this way, the image selection engine 310 may make refined selections that are tailored to the specific user.

It will be appreciated that the output of an image selection engine 310 may characterize the salience of an image in a variety of ways. For example, as described above, the image selection engine 310 may, for each captured image or image contents, determine a binary salience score. That is, the image selection engine 310 may determine that a captured image is either salient (e.g., a salience score of 1) or not salient, (e.g., a salience score of 0) such that only salient images are selected for later usage in the synthetic image generation process. On the other hand, the image selection engine 310 may, for each captured image or image contents, determine a graduated salience score. That is, the image selection engine 310 may determine that a captured image has a salience score falling within a range (e.g., 0 to 1, or another arbitrary range). In this example, no absolute determination that an image is “salient” or “not salient” may occur, and thus the image selection engine 310 may further be configured to only select captured images corresponding to salience scores over a particular salience threshold condition, to only select a particular number of the highest salience scoring captured images, and the like.

In examples where a salience condition is employed, the salience condition may be a static threshold value, or a dynamic threshold value adjusted by the image selection engine 310 in response to the other salience determinations for other captured images. It will be appreciated that the image selection engine 310 may be configured to revise particular salience determinations progressively in response to other salience determinations that are made. For example, in a collection where the highest salience score given is 999, the image selection engine 310 may automatically set the salience threshold to 900. In another example, the collection of captured images may include several thousand images, with salience scores ranging from 1 to 100. The salience threshold may be configured such that only ten captured images of the collection are preserved for later synthetic image generation, i.e., only the ten captured images corresponding to the top ten highest salience scores will be selected for further processing via the image synthesis pipeline 302. Other techniques for scaling salience scores and/or selecting images based on salience scores are also contemplated.

As mentioned, the salience threshold may be static. In examples utilizing a static salience threshold condition, the quantity of images that are selected for later synthetic image generation may vary depending on the related saliences of the collection of captured images. For instance, where a static salience threshold is employed, if image selection occurs daily, and the user spent a particular day traveling the Galapagos Islands, a substantially greater number of images will be selected than if the user spent that particular day at work (e.g., because the work photos will generally have lower salience). Thus, it will be appreciated that the salience threshold and the manner and time period in which captured images are compiled into a collection may appreciably relate to the quantity of captured images that will be selected, and by extension, the quantity of synthetic images that may later be generated.

Similarly, it will be appreciated that the various manners of determining and evaluating salience for a particular collection may be adjustable by the user or in response to user requirements. For example, a user may desire fewer synthetic images, which may correspond to a heightening of the salience threshold in the image selection engine (and optional adjustments to the interval in which automatic image captures occur). As another example, a user may directly lower a salience threshold for a collection of captured images in order to generate more synthetic images from the collection.

In some cases, images may further be selected based in part on supplemental data items 306 (e.g., metadata) associated with the images. For example, supplemental data may include location data about where the image capture occurred (e.g., GPS data), as well as historical location data relating to the user. The image selection engine 310 may therefore be configured to determine that an image was captured at a location the user rarely visits, or that the image was captured at a location within the user's ordinary routines. For example, an image capture may be associated with GPS coordinates corresponding to a particular mountain range or landmark, and the historical location data may include no entries corresponding to the location. Using this information, the image selection engine 310 may determine that, because the supplemental data relating to the image capture does not correspond to a particular routine of the user, the image capture is likely of higher salience. In this way, the supplemental data associated with an image may be incorporated by the image selection engine 310 (and/or an image selection model used by the image selection engine 310) to formulate a selection of images that are of overall higher salience to the user.

Once the image selection engine 310 selects a subset of images from a collection of captured images, the selected subset of image may be provided as inputs to the image analysis engine 314. The image analysis engine 314 as described herein may be configured to produce a text-based summary of images received as input, and further be configured to isolate or otherwise identify particular regions of the images received as described herein. The text-based summaries produced by the image analysis engine 314 may include detailed descriptions of contents associated with higher salience determinations, or entirely omit descriptions of contents associated with lower salience determinations. Similarly, as described herein, the particular regions of the received images that are segmented by the image analysis engine 314 may correspond to contents determined to be highly salient. The image analysis engine 314 may be further configured to output transcriptions of various text identified within the captured images.

The output of the image analysis engine 314, which may include a text-based summary and, optionally, segments of the captured image and/or information identifying region(s) of the captured image that contain important features for faithful representation, is then provided to prompt generation engine 316. The prompt generation engine 316 may be configured to further accept the supplemental data items 306 as described herein. As mentioned, supplemental data items 306 may include metadata, location information, timestamps, camera or image parameters, and the like. As described herein, the prompt generation engine 316 may use such data to, for example, make specific reference to geographical locations, landmarks, or the like. For example, the image analysis engine 314 may use supplemental data items 306, such as GPS data, compass/heading data, inertial measurement unit data, or the like, to determine that the user was facing a particular landmark (e.g., the Golden Gate Bridge) when an image was captured, and include specific reference to that landmark in the text-based summary.

The prompt generation engine 316 may be configured to produce a prompt for the image generation engine 318. It will be appreciated that the particular format and contents of a prompt generated by the prompt generation engine 316 substantially define the basis for which synthetic images will be generated. The prompt generation engine 316 may therefore incorporate the output of the image analysis engine 314 (e.g., all or a portion of the text-based summary), and further include various additional specifications and criteria, for instance, those defined by particular user settings for synthetic image generation.

Further, because a user may select that synthetic images are to be generated to depict particular perspectives and art styles, the prompt generation engine 316 may be configured to modify or include additional details over the inputs given by the image analysis engine 314. For example, the prompt generation engine 316 may make various additions and alterations to the text-based summary provided by image analysis engine 314 to comport with user requirements (e.g., particular user settings for synthetic image generation) or other established system configurations. Similarly, the supplemental data items 306 may be provided to and used by the prompt generation engine 316. For example, the prompt generation engine 316 may incorporate supplemental data items 306 containing weather information such that language describing the weather is contained in the text-based prompt. For instance, a user may request that synthetic images depict a particular perspective and art style, such as a wide third-person landscape perspective and medieval tapestry style, and the supplemental data items 306 may indicate that the weather was sunny when a corresponding image capture occurred. Accordingly, for a text-based summary generated by the image analysis engine 314 that recites, “generate a first-person perspective photograph of the Golden Gate Bridge from Delores Park,” the prompt generation engine 316 may correspondingly produce a text-based prompt that reads, “generate a medieval tapestry showing a wide landscape view of the Golden Gate Bridge on a sunny day.” In this way, the particular look and feel of generated synthetic images may be defined, modified, and otherwise adjusted by the prompt generation engine 316.

The prompt generated by the prompt generation engine 316 may then be provided as input to the image generation engine 318. It will be appreciated that the prompt generated by the prompt generation engine 316 is formatted in a manner that is expected by the image generation engine (and/or any associated machine learning models of the image generation engine), such that the prompt can be provided directly to the image generation engine.

The image generation engine 318 may include one or more image generation models configured to accept text-based inputs (e.g., the prompt from the prompt generation engine 316), and optionally image-based inputs (or combinations of text, images, and/or other information types). For instance, image generation engine 318 may include a text-to-image generation model, an image-to-image generation model, and the like. Further, the image generation engine 318 may be configured to accept a combination of input types, including text-based inputs (e.g., the text-based prompt), image-based inputs (e.g., regions of a particular image), and the supplemental data items 306. The image generation engine 318 may then accordingly generate one or more synthetic images that thereby correspond to the captured images 304 that were selected by the image selection engine 310 and for which an image generation prompt was generated. The one or more synthetic images generated by the image generation engine 318 may then be stored and/or displayed on a client device 308.

The image selection engine 310 may include one or more image selection models. The image selection models may include machine learning models, such as image-to-text machine-learning models. Image-to-text machine learning models as described herein may include caption generation machine learning models, optical character recognition machine learning models, and the like. Further, the image selection engine 310 may include other models, such as text classification machine learning models, large language models, natural language processing models, and the like. For example, the image selection engine 310 may apply a caption generation machine learning model to generate captions for a captured image, and subsequently apply a natural language processing model to determine the importance of particular terms within the generated captions. It will be appreciated that the models described herein may implement a number of machine learning techniques and structures, including convolutional neural networks, generative adversarial networks, deep learning, visual geometry grouping, and may additionally include supervised, semi-supervised, and unsupervised learning algorithms.

The image analysis engine 314 may include one or more image analysis models. The image analysis models may include machine learning models, such as image-to-text machine learning models. As described, image-to-text machine learning models may include caption generation machine learning models, optical character recognition machine learning models, and the like. Further, the image analysis engine 314 may include other models, such as text classification machine learning models, large language models, natural language processing models, and the like. For example, the image analysis engine 314 may utilize an optical character recognition machine learning model to produce a transcription of text captured within an image, and subsequently apply a text classification machine learning model to determine whether the text is of particular importance. As described herein, the image analysis engine 314 may further include a feature identification engine. The feature identification engine may include machine learning models configured to extract or otherwise identify particular features within a captured image, such as the image-to-text models described herein.

The prompt generation engine 316 may include one or more prompt generation models. The prompt generation models may include machine learning models, such as text classification machine learning models, large language models, natural language processing models, and the like. For example, the prompt generation engine may apply a large language model to formulate a prompt using the inputs received from the image analysis engine 314.

The image generation engine 318 may include one or more image generation models. The image generation models may include machine learning models, such as text-to-image machine learning models. Text-to-image machine learning models as described herein may include latent diffusion models, generative image models, deep convolutional generative adversarial models, and the like. For example, the image generation engine 318 may apply a latent diffusion model to generate a synthetic image based on a prompt received from the prompt generation engine 316. It will be appreciated that the models described herein may implement a number of additional machine learning techniques and structures, including other forms of convolutional neural networks, generative adversarial networks, deep learning, visual geometry grouping, and may additionally include supervised, semi-supervised, and unsupervised learning algorithms.

In some examples, the image generation engine 318 may include image-to-image machine learning models such as generative adversarial networks, variational autoencoders, latent diffusion models, and the like. For example, the image generation engine 318 may be configured to apply an image-to-image model to a captured image and/or image segments as described to produce a synthetic image as output. The outputs of the image analysis engine 314 and prompt generation engine 316 may in some cases be interpreted as additional parameters for an image-to-image machine learning model. Similarly, the image generation engine 318 may be configured to directly accept user-defined parameters for image-to-image generation as described (e.g., a user may select a particular art style that a synthetic image should resemble). In this way, the image generation engine 318 may produce a synthetic image that emphasizes the particular contents of a captured image, stylizes the captured image, and the like, such that the generated synthetic image is more desirable to a user.

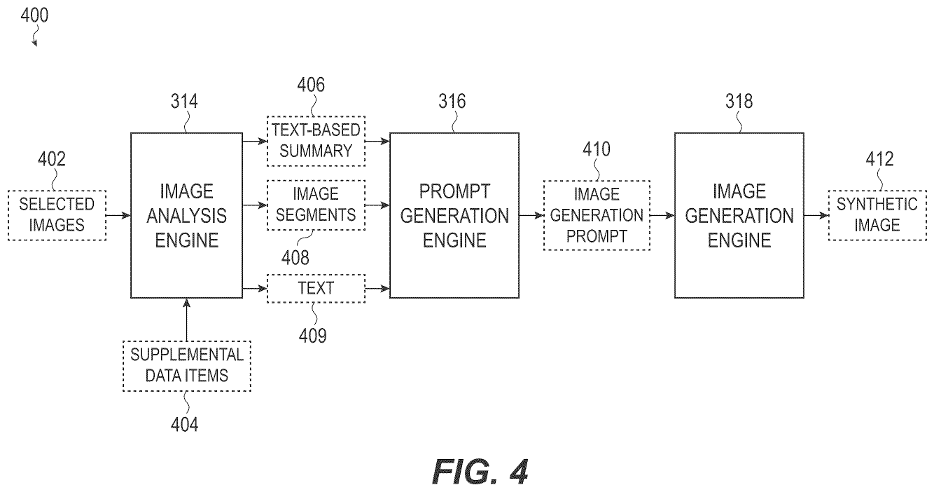

FIG. 4 depicts an example portion of a synthetic image generation pipeline 400 through which selected images 402 may be processed in order to produce synthetic images 412. As depicted, selected images 402, and optionally supplemental data items 404, are provided as input to the image analysis engine 314, and the image analysis engine 314 produces, as output, text-based summaries 406. In some cases, the image analysis engine 314 may also produce, as output, information that identifies image segments 408 and text 409. As described herein, the information that identifies image segments 408 may identify particular segments of an image that have high salience or contribute to the salience of the image (e.g., a landmark, prominent people or faces), particular segments of an image that should be faithfully or accurately represented in the synthetic image (e.g., faces), or the like. As previously described, image segments 408 may include excerpted regions of a selected image, identifiers for particular regions of a selected image, and the like. For instance, an image segment may include an identifier of a particular region of a captured image including a highly salient object within the image such that the image segment may be referenced, incorporated, or otherwise provided as additional input for use by the image generation engine 318, further ensuring that the highly salient object is faithfully represented in the synthetic image.

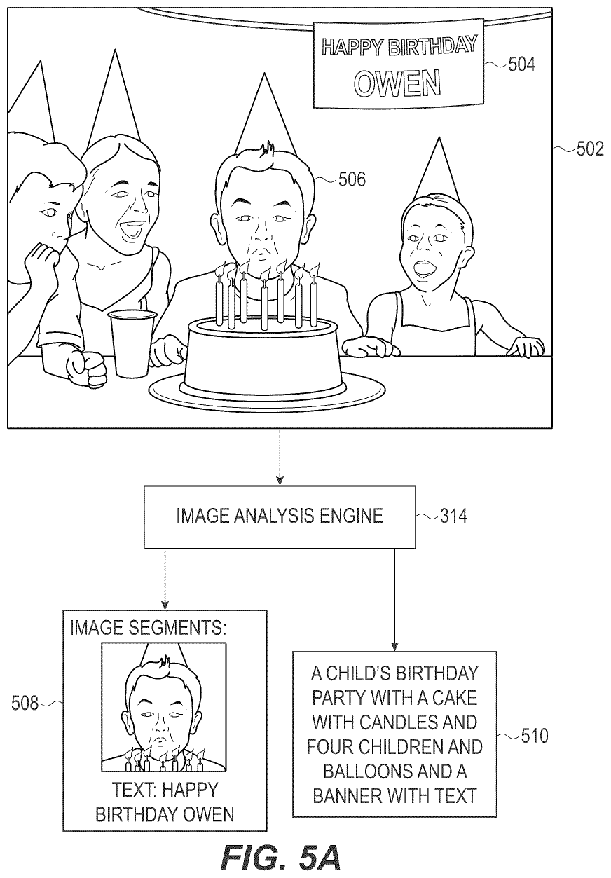

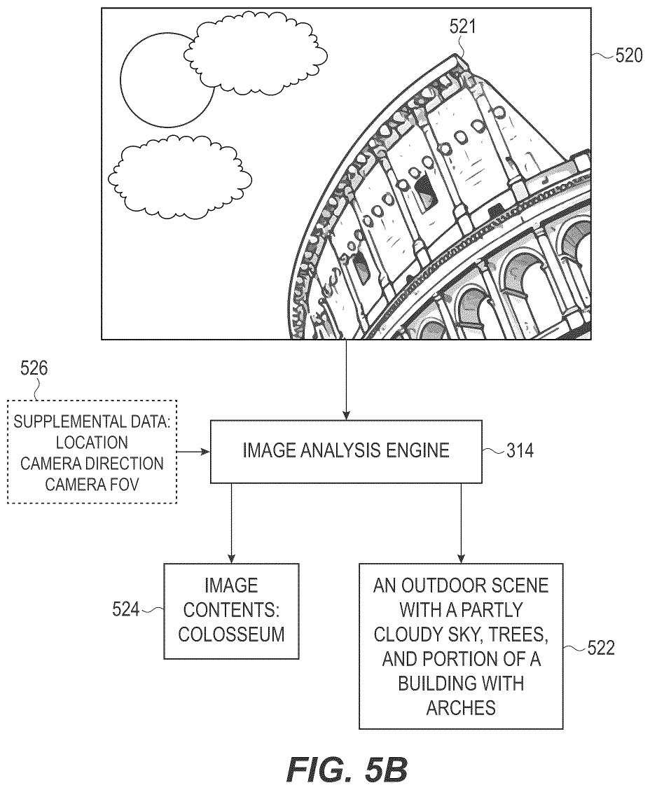

Captured images may include text-based information that should be faithfully reproduced or represented in a synthetic image, as described in greater detail with respect to FIG. 5 (e.g., birthday banner 504). The image analysis engine 314 may therefore be configured to produce, as output, text 409 corresponding to the identified text-based information in a captured image, in addition to the text-based summary 406. In some cases, text identified in a captured image may be incorporated directly into the text-based summary 406, rather than being provided as a separate output from the image analysis engine 314.

The prompt generation engine 316 may accept the text-based summaries 406 and the optional image segments 408 and text 409, as input, and produce an image generation prompt 410 as output. As mentioned, the image generation prompt 410 may include a variety of information. For example, the image generation prompt 410 may be a solely text-based prompt, a series of image segments (e.g., identifiers of particular regions within captured images), text transcriptions, combinations thereof, etc.

The image generation prompt 410 produced by the prompt generation engine 316 is provided as input to the image generation engine 318. As described, the image generation engine 318 is configured to output synthetic images 412 corresponding to the selected images 402 (e.g., based on the textual description of the selected images 402 from the image analysis engine 314 and optionally other information, as described herein). Further, as described, the contents and aspects of synthetic images 412 may be emphasized, omitted, or otherwise differently depicted relative to the corresponding selected images 402.

As described, the image analysis engine 314 may identify image segments in a captured image so that the contents in those segments can be faithfully or accurately represented in corresponding synthetic images. The image generation techniques described herein in some cases produce a text-based description of a captured image, and then generate the synthetic image based on the text-based description. Accordingly, in generating the text-based description of the image certain information that may be important to the meaning of the image may be lost and ultimately not accurately represented in the synthetic image.

FIG. 5A illustrates how a particular region of an image 502 may be identified by the image analysis engine 314 as being important for faithful representation in the synthetic image. For instance, the image analysis engine 314 may identify the birthday banner 504 and child 506 within the image, and produce additional output 508 in the form of the image segment and text. In some examples, by referencing a user's contacts or photo library, the image analysis engine 314 may determine that a particular person (e.g., child 506), location, or other content identified within an image capture is of close relation or familiarity to the user. Accordingly, the image analysis engine 314 may be configured to make salience determinations in part based upon the relationship or familiarity of particular image contents to the user as described, such that the contents are accurately or otherwise desirably depicted in the synthetic images. In this way, the image analysis engine 314 may determine that the child 506 is an important feature of the image that should be faithfully represented in corresponding synthetic images, and thus produce information identifying the region of the image that child 506 appears within.

Further, the birthday banner 504 may be determined to be similarly important, and thus a corresponding transcription of the sign's text may be produced. Accordingly, the image analysis engine 314 may produce the additional output 508 containing the region of the image containing child 506 and a transcription of the birthday banner 504. While FIG. 5A illustrates the image analysis engine 314 providing an actual image segment as output, this is merely for illustration, and the actual output need not be an actual image (e.g., an image file), but rather may be information identifying the region of the captured image where the important feature is located, which may ultimately be provided to the image generation engine 318 so that the image generation engine 318 can accurately represent the important feature or subject.

Further, as described herein, the image analysis engine 314 may produce a text-based summary 510 using, for instance, the techniques described in relation to FIG. 3. As depicted, the text-based summary 510 includes a description of the selected image 502. The text-based summary 510 includes descriptions of various salient contents within the image, for instance, “a cake with candles.” Notably, the text-based summary 510 does not provide sufficient detail to reproduce or represent the important contents of the image, including the details of the child's appearance or the text in the banner. Thus, as described above, the image generation engine 318 as described herein may incorporate or use the image segment in the additional output 508 when producing a synthetic image that includes the child 506, such that a synthetic depiction of child 506 substantially resembles the child as depicted in the captured image. Further, the child 506 may correspond to supplemental data items as described herein (e.g., other photographs within the user's photo library that contain the child 506). Thus, the image analysis engine 314 may identify particular image segments and provide text-based summaries in part based on the supplemental data indicating that the child frequently appears in photographs taken by the user, as described herein.

Thus, the additional output 508 provides additional information that the image generation engine 318 can use in order to faithfully represent the important aspects of the captured image. It will be appreciated that these are merely examples of the text-based summaries that an image analysis engine 314 as described herein may be configured to provide. For instance, a text-based summary (e.g., 510) may include significantly more or fewer words, and similarly include differing levels of detail in the description of the various contents of the image. Additionally, image segments identified by the image analysis engine 314 may be of various dimensions, or comprise an identifier of the location at which a particular segment may be found within a selected image. Further, the image analysis engine 314 may output one or more image segments relating to various contents of the image.

While the foregoing example illustrates a child and banner text as image subjects that are to be faithfully or accurately represented in the synthetic image, it will be appreciated that these are merely examples, and that other types of image contents may be identified by the image analysis engine 314 for faithful representation.

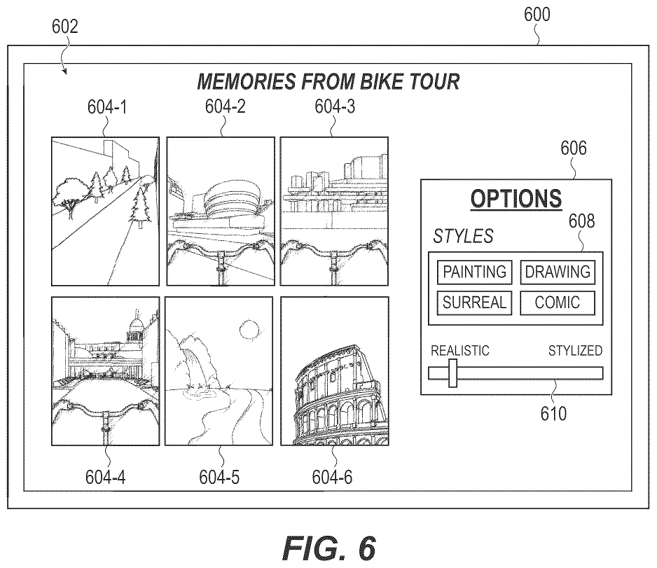

Additionally or alternatively, the image analysis engine 314 may be configured to analyze supplemental data 526 (e.g., image metadata) in order to improve the quality and relevance of the synthetic images that are generated. FIG. 5B illustrates how the image analysis engine 314 may produce a text-based summary 522 as output, as well as additional output 524 from the selected image 520 and supplemental data 526. More particularly, because the selected image 520 may include only a small portion of a particular landmark 521 (e.g., due to the nature of the automatic image capture functions described herein), techniques for identifying the contents of an image based on the image alone may misidentify the landmark, or otherwise fail to determine that the small portion corresponds to the particular landmark. As a result, the text-based summary 522 may not include some pertinent information about the landmark. For instance, the image may contain an unidentifiable portion of the Roman Colosseum (e.g., portion of landmark 521), and thus the corresponding text-based summary may simply refer to the Colosseum as “a building.” Thus, supplemental data 526 (which, as shown, includes location, camera direction, and camera field of view, though these are merely examples) may be analyzed by the image analysis engine 314 in order to help ensure that important features of an image are faithfully represented in the synthetic image. In this way, the image analysis engine 314 may determine that the user's location, in association with the camera's direction and field of view, indicate that the user was in close proximity to (and/or facing) the Colosseum when the selected image was captured, and further may indicate that a captured image would likely contain a portion of the Colosseum. Accordingly, the image analysis engine 314 may produce an additional output 524 in the form of identification of particular image contents (e.g., “IMAGE CONTENTS: COLOSSEUM”) in addition to the text-based summary 522. Further, the image analysis engine 314 may be configured to integrate the particular contents identified in this manner directly into the text-based summary 522. As a result of identifying the particular object and providing the information to the image generation engine, the synthetic image for this captured image may ultimately display the correct object (e.g., as shown in the example generated synthetic image 604-6 in FIG. 6, which includes a better depiction of the Colosseum). It will be understood that a faithful representation in a synthetic image need not be an exact reproduction of an image or image contents, but rather may be a representation that would be understood, by an observer, to represent a particular object or entity. In some cases, however, an actual image or exact reproduction of image contents may be incorporated into a synthetic image.

FIG. 6 illustrates an example user interface 602 for displaying generated synthetic images (e.g., 604-1, . . . , 604-6) on a client device 600. As described previously, the synthetic image generation operations described herein may allow a user to change, modify, or otherwise control aspects of the operations, such as to change the artistic look and feel of synthetic images. As depicted, the user interface 602 includes an options pane 606 with which a user may provide inputs indicating the desired look and feel of generated synthetic images 604. The example options pane 606 includes various stylistic options 608 selectable by the user, as well as a photorealism slider 610 adjustable by the user to control and/or adjust the degree to which a particular style is applied to the correspondingly generated synthetic image. It will be appreciated that these are merely examples of the input fields that an options pane 606 may include. In some examples, an options pane may include an editable text field initialized using the text-based prompt produced by the prompt generation engine 316, such that the user may manually revise the text-based prompt given to the image generation engine 318. Similarly, in some examples, the options pane may include a perspective adjustment pane with which a user may select a preferred perspective or composition for the synthetic image (e.g., third-person wide landscape).

As depicted, generated synthetic images 604 are displayed in a collective view that may represent the entire period over which selected images were captured (e.g., as memories from a bike tour). The generated synthetic images are made available to the user such that they may be downloaded, stored, shared, copied, or otherwise manipulated by the user. It will be appreciated that the generated synthetic images may be displayed in a variety of manners, such as in a timestamped list or one image at a time. Further, generated synthetic images may be stored such that they are searchable by the user. For instance, the collection of synthetic images may be stored with a searchable label, “memories from bike tour.”

It will be appreciated that FIG. 6 merely illustrates an example of a user interface 602 and client device 600 that may display synthetic images. The user interface 602 may include additional panes, fields, or other graphical user interface elements. In some examples, user interface 602 may include, for each generated synthetic image 604, a contextual summary pane that contains a description of the time, location, and manner of capture for the selected image corresponding to the synthetic image. Client device 600 may include mobile devices, tablets, laptops, televisions, or other electronic devices.

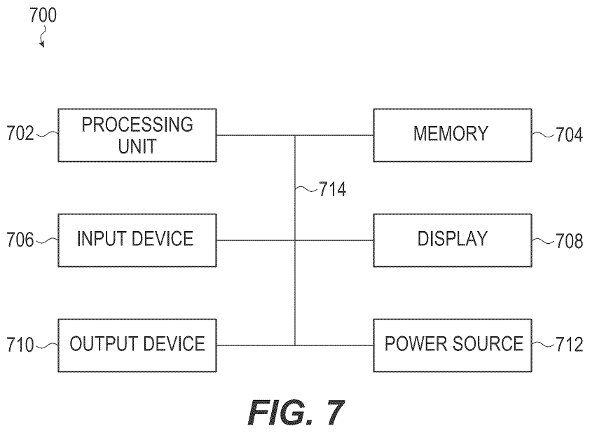

FIG. 7 shows a sample electrical block diagram of an electronic device 700 that may perform the operations described herein. The electronic device 700 may in some cases take the form of any of the electronic devices described with reference to FIGS. 1-6, including client devices, display devices, and/or servers or other computing devices associated with the image synthesis techniques described herein. For example, the image synthesis pipeline 302 (FIG. 3) may be instantiated and/or executed by one or more electronic devices 700. For instance, the image selection engine 310 may be instantiated on a first instance of the electronic device 700 (e.g., a smartphone), while the image analysis engine 314 may be instantiated on a second instance of the electronic device 700 (e.g., a cloud computing system), such that the first and second instances of the electronic device 700 may communicate and cooperate without impeding the behavior of the pipeline. In this way, the image selection engine 310, the image analysis engine 314, the prompt generation engine 316, the image generation engine 318, and the like may be instantiated across multiple instances of the electronic device 700, or may be combined within a single instance of electronic device 700. Similarly, the client device(s) 308, and optionally the image capture devices described herein, may also be instances of the electronic device 700.

The electronic device 700 can include one or more of a processing unit 702, a memory 704 or storage device, input devices 706, a display 708, output devices 710, and a power source 712. In some cases, various implementations of the electronic device 700 may lack some or all of these components and/or include additional or alternative components. Similarly, the processes, methods, techniques, and operations described herein (e.g., image capture, machine learning, and the like) may be executed or otherwise instantiated over one electronic device 700, or over multiple instances of electronic device 700 that are operatively connected (e.g., by wireless communication).

The processing unit 702 can control some or all of the operations of the electronic device 700. The processing unit 702 can communicate, either directly or indirectly, with some or all of the components of the electronic device 700. For example, a system bus or other communication mechanism 714 can provide communication between the processing unit 702, the power source 712, the memory 704, the input device(s) 706, and the output device(s) 710.

The processing unit 702 can be implemented as any electronic device capable of processing, receiving, or transmitting data or instructions. For example, the processing unit 702 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 700 can be controlled by multiple processing units. For example, select components of the electronic device 700 (e.g., an input device 706) may be controlled by a first processing unit and other components of the electronic device 700 (e.g., the display 708) may be controlled by a second processing unit, where the first and second processing units may or may not be in communication with each other.

The power source 712 can be implemented with any device capable of providing energy to the electronic device 700. For example, the power source 712 may be one or more batteries or rechargeable batteries. Additionally, or alternatively, the power source 712 can be a power connector or power cord that connects the electronic device 700 to another power source, such as a wall outlet.

The memory 704 can store electronic data that can be used by the electronic device 700. For example, the memory 704 can store electronic data or content such as, for example, image files (e.g., still and/or video images, synthetic images), audio files, documents and applications, device settings and user preferences, timing signals, control signals, and data structures or databases. The memory 704 can be configured as any type of memory. By way of example only, the memory 704 can be implemented as random access memory, read-only memory, flash memory, removable memory, other types of storage elements, or combinations of such devices.

In various embodiments, the display 708 provides a graphical output, for example associated with an operating system, user interface, and/or applications of the electronic device 700 (e.g., a synthetic image viewing user interface, such as the user interface 602 of FIG. 6). In one embodiment, the display 708 includes one or more sensors and is configured as a touch-sensitive (e.g., single-touch, multi-touch) and/or force-sensitive display to receive inputs from a user. For example, the display 708 may be integrated with a touch sensor (e.g., a capacitive touch sensor) and/or a force sensor to provide a touch-and/or force-sensitive display. The display 708 is operably coupled to the processing unit 702 of the electronic device 700.

The display 708 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 708 is positioned beneath and viewable through a cover that forms at least a portion of an enclosure of the electronic device 700.

In various embodiments, the input devices 706 may include any suitable components for detecting inputs. Examples of input devices 706 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., dials, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 706 may be configured to detect one or more particular types of input and provide a signal (e.g., an input signal) corresponding to the detected input. The signal may be provided, for example, to the processing unit 702.

The output devices 710 may include any suitable components for providing outputs. Examples of output devices 710 include light emitters, audio output devices (e.g., speakers), visual output devices (e.g., lights or displays), tactile output devices (e.g., haptic output devices), communication devices (e.g., wired, or wireless communication devices), and so on, or some combination thereof. Each output device 710 may be configured to receive one or more signals (e.g., an output signal provided by the processing unit 702) and provide an output corresponding to the signal.

In some cases, input devices 706 and output devices 710 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 702 may be operably coupled to the input devices 706 and the output devices 710. The processing unit 702 may be adapted to exchange signals with the input devices 706 and the output devices 710. For example, the processing unit 702 may receive an input signal from an input device 706 that corresponds to an input detected by the input device 706. The processing unit 702 may interpret the received input signal to determine whether to provide and/or change one or more outputs in response to the input signal. The processing unit 702 may then send an output signal to one or more of the output devices 710, to provide and/or change outputs as appropriate.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above, below, over, under, left, or right (or other similar relative position terms), do not necessarily refer to an absolute position relative to an external reference, but instead refer to the relative position of components within the figure being referred to.

What is claimed is:

1. A method for generating a set of synthetic images corresponding to a subset of images of a collection of captured images, comprising:
receiving the collection of captured images, the collection of captured images captured by an electronic device, each image of the collection of captured images having image content;
providing the collection of captured images as input to an image selection model trained to select, from the collection of captured images, a subset of images that satisfy a salience condition;
receiving, as output from the image selection model, respective identifiers of the images of the subset of images that satisfy the salience condition; and
for an image of the subset of images that satisfies the salience condition:
providing the image as input to an image analysis model;
receiving, as output from the image analysis model, a text-based summary of the image content of the image;
generating a prompt for an image generation model, the prompt including the text-based summary of the image;
receiving, as output from the image generation model, a synthetic image including a computer-generated representation of the image content of the image; and
causing the synthetic image to be displayed on an image display device.

2. The method of claim 1, wherein:
the electronic device is an earbud;
the electronic device comprises a first camera having a first field of view and a second camera having a second field of view different from the first field of view; and
the first camera and the second camera are positioned in the earbud such that the first camera is aimed in a first direction when the earbud is worn and the second camera is aimed in a second direction different from the first direction when the earbud is worn.

3. The method of claim 2, wherein:
the first direction is oriented laterally relative to the electronic device; and
the second direction is a forward direction relative to the electronic device.

4. The method of claim 1, wherein:
the electronic device is a wearable electronic device; and
the images of the collection of captured images captured by the wearable electronic device are automatically captured at periodic intervals over a time period.

5. The method of claim 1, wherein at least a subset of images of the collection of captured images captured by the electronic device are captured in response to a voice command.

6. The method of claim 1, wherein:
the image selection model is trained using a plurality of annotated image sets; and
an annotated image of an annotated image set of the plurality of annotated image sets is annotated with a salience score.

7. The method of claim 1, wherein:
the image of the subset of images is associated with image metadata;
the image metadata is provided to the image analysis model as an additional input associated with the image;
the image analysis model provides, as an additional output, an identifier of an image subject in the image based at least in part on the image metadata; and
the prompt further includes the identifier of the image subject.

8. The method of claim 7, wherein the image metadata includes location information indicating an image capture location of the image and camera orientation information indicating an orientation direction of a camera when the image was captured.

9. The method of claim 1, wherein the collection of captured images comprises one or more still images excerpted from a video captured by the electronic device.

10. A method for generating a set of synthetic images corresponding to a subset of a collection of captured images, comprising:
selecting a captured image from the collection of captured images, the selection based at least in part on a salience of image content of the captured image, the captured image associated with image metadata;
providing the captured image as input to an image analysis model;
receiving, as output from the image analysis model, a text-based summary of the image content of the captured image;
generating a prompt for an image generation model, the prompt including the text-based summary of the image content of the captured image and at least one supplemental data item from the image metadata;
receiving, as output from the image generation model, a synthetic image including a computer-generated representation of the image content of the captured image, wherein the computer-generated representation is generated based at least in part on the at least one supplemental data item; and
causing the synthetic image to be displayed on an image display device.

11. The method of claim 10, wherein selecting the captured image comprises:
receiving the collection of captured images, the collection of captured images captured by an electronic device;
providing the collection of captured images as input to an image selection model trained to select, from the collection of captured images, a subset of images that satisfy a salience condition; and
receiving, as output from the image selection model, an identifier of the captured image.

12. The method of claim 10, wherein:
the method further comprises:
providing the captured image to an image feature identification engine that is configured to identify features of the captured image to be accurately represented in the synthetic image; and
receiving, as output, from the image feature identification engine, an identifier of a region of the captured image corresponding to a candidate feature to be accurately represented in the synthetic image;
the operation of generating the prompt for the image generation model further includes incorporating the identifier of the region of the captured image in the prompt; and
the synthetic image includes an accurate representation of the candidate feature.

13. The method of claim 12, further comprising:
generating an image segment file corresponding to a segment of the captured image, the segment of the captured image including the candidate feature; and
providing the image segment file as an additional input to the image generation model in conjunction with the prompt.

14. The method of claim 13, wherein the image feature identification engine is configured to identify the candidate feature based at least in part on a determination that the candidate feature appears in at least one other image in the collection of captured images.

15. The method of claim 13, wherein the image feature identification engine is configured to identify the candidate feature based at least in part on a determination that the candidate feature appears in a reference image.

16. A method for generating a set of synthetic images corresponding to a subset of a collection of captured images, comprising:
receiving the collection of captured images, the collection of captured images automatically captured by a wearable camera while the wearable camera is being worn;
providing the collection of captured images as input to an image selection model, the image selection model trained to select, from the collection of captured images, a subset of captured images that satisfy a salience condition;
receiving, as output from the image selection model, the subset of captured images; and
for an image of the subset of captured images, generating, with an image generation model, a synthetic image including a computer-generated representation of image content of the image.

17. The method of claim 16, wherein:
the collection of captured images is captured by the wearable camera periodically at a time interval; and
the time interval is adjusted by the wearable camera based at least in part on geolocation data associated with the wearable camera.

18. The method of claim 16, further comprising, prior to providing the collection of captured images as input to the image selection model:
determining a similarity score between at least two images of the collection of captured images; and
in accordance with a determination that the similarity score satisfies a similarity condition, selecting, from the at least two images, a single representative image to include in the collection of captured images that is provided as input to the image selection model.

19. The method of claim 16, wherein:
the image of the subset of captured images is provided to an image analysis model;
the image analysis model is configured to output a text-based summary for the image of the subset of captured images; and
the text-based summary is provided as input to the image generation model.

20. The method of claim 19, wherein:
the image analysis model receives one or more supplemental data items including at least an image capture location of the image of the subset of captured images; and
the text-based summary for the image of the subset of captured images includes information about a location identified from the image capture location.
